(19) United States
(12) Patent Application Publication
(10) Pub. No.: US 2004/0198577 A1
(43) Pub. Date: Oct. 7, 2004

(54) Device and process for blank separation in a machine producing pieces of flat material cut out of a web

(76) Inventor: Martin Blumle, Horhausen (DE)

Correspondence Address: OSHA & MAY L.L.P., 1221 MCKINNEY STREET, HOUSTON, TX, 77010, US

(21) Appl. No.: 10/754,086

(22) Filed: Jan. 8, 2004

(30) Foreign Application Priority Data
Jan. 8, 2003 (DE) 103 00 234.0

(51) Int. Cl. B31F 1/00

(52) U.S. Cl. 493/413

(57) ABSTRACT

A device for blank separation in a machine producing pieces of flat material cut out of a web is described, in which the web in one direction of conveyance is guided through the machine, and the web comprises at least two rows of blanks at right angles to the direction of conveyance, and in which the device comprises a cutting roll for cutting pieces of flat material out of the web. This device is to be improved in such a manner that it is possible to feed the pieces of flat material to an automated delivery, with the rows of blanks being positioned in relatively close proximity. As a solution to this problem it is proposed to provide a blank separating roll which accepts the cut out flat pieces of material of each row of blanks and comprises a vacuum device for retaining the pieces of flat material at the peripheral area of said device, in which at least two conveyors are provided and in which the vacuum device is so controllable that the pieces of flat material allocated to the first row of blanks can be delivered in a first tangential direction of the row of blanks to the first conveyor, and the pieces of flat material allocated to the second row of blanks can be delivered in the second tangential direction of the blank separating roll to the second conveyor.

### FIELD OF APPLICATION

The present invention relates to a device and process for blank separation in a machine producing pieces of flat material cut out of a web. Pieces of flat material within the scope of the present invention, for example, are wet gummed labels made of paper and/or similar materials or food container lids made of aluminum or similar materials. Wet gummed labels particularly are applied to bottles of any type, above all, beverage bottles as well as food glass jars, such as jars containing sandwich spreads of any type. Food container lids made of aluminum, for example, may be yogurt cup lids or the like. Furthermore, other pieces of flat material, such as envelope blanks, may be pieces of flat material within the scope of the present invention.

### TECHNICAL BACKGROUND

It is generally known that wet gummed labels for beverage bottles and similar containers are punched out from a stack of layered paper by means of the so-called lift-punching process. This process reaches its limits if relatively complicated label geometries are to be produced, such as the shape of the known Smirnoff Vodka label. Furthermore, the lift-punching process is unusable if the labels to be produced are to be provided with impressions and/or perforations. In particular, inside impressions, such as windows in labels or envelopes, cannot be produced with the lift-punching process. Furthermore, it also is known to produce self-adhesive labels or yogurt cup lids made of aluminum. Further, a web is guided via a rotating cutting roll, which cuts pieces of material out of the web which have the required geometry of the self-gummed label and/or the yogurt cup lid. Subsequently, the cut out pieces of material are collected in collectors.

With the process by way of rotation, the objective always is to cut pieces of flat material out of the web in such a manner that a minimum of unused web remains as waste. This can be achieved by means of optimization processes which, as a function of the geometry of the pieces of flat material to be cut out, produce the optimum configuration of contour lines of the individual pieces of flat material on the web. This type of optimization regularly produces several rows of contours of pieces of flat material to be cut out, which run in the longitudinal direction of the web, said pieces being usually provided with the desired lettering prior to cutout. Because of the optimization goal of keeping the waste produced by the paper web as low as possible, said rows frequently interfere with each other. In the following, the aforesaid rows are referred to as blank rows. The greater the number of blank rows, which can be provided with the specified width of the web, the greater the number of pieces—also referred to as blanks—of flat material which can be cut out the web per rotation of the cutting roll and thus per time unit.

The generally known devices and/or processes for cutting self-adhesive labels or yogurt cut lids by way of rotation are inadequate, as far as the delivery of completely cut-out pieces of flat material is concerned. Especially, with the endeavored high degree of utilization, i.e., with a relatively high number of pieces of flat material cut out per time unit, automation in the area of delivering pieces of flat material is desirable. This type of automation first of all requires that, due to optimizing waste, the pieces of flat material produced within the very narrow space behind the cutting roll are spaced in such a manner that said pieces can be fed to an automated delivery. In the following, this spacing process is referred to as blank separation.

### PRESENTATION OF THE INVENTION

a) Technical Problem

Accordingly, it is the object of the present invention to create a device and a process for blank separation in a machine producing flexible pieces of flat material, which are cut out of a web, enabling said pieces to be fed to an automated delivery, with the rows of blanks being positioned in relatively close proximity.

b) Solution of the Problem

The foregoing object is achieved in the present invention by means of a device or a process comprising the characteristic elements of claim 1 and/or 6. Further developments of the invention arise from the subordinate claims.

According to the invention, it is proposed to place a blank separating roll suitable for vacuum application in front of the cutting roll also suitable for vacuum application, in the direction of conveyance, said blank separating roll accepting directly or indirectly the flexible pieces of flat material of every row of blanks, which are cut by the cutting roll. Further, the vacuum device so controls both the cutting roll and the blank separating roll that the pieces of flat material, after and/or while being cut out of the web, are still retained by means of vacuum at the cutting roll via a certain angle at circumference. After passing through this given angle at circumference, the cutting roll delivers the pieces of flat material preferably directly to the blank separating roll, in which the pieces of flat material are retained at the blank separating roll after having been delivered by means of vacuum. Also feasible is an indirect delivery of the pieces of flat material from the cutting roll to the blank separating roll, in which in this case additional conveyors, especially conveyor rolls, are placed between the cutting roll and the blank separating roll.

If only two rows of blanks are provided, the pieces of flat material allocated to the first row of blanks are retained at the blank separating roll by means of vacuum via a greater angle at circumference than the pieces of flat material allocated to the second row of blanks. In other words, the pieces of flat material, which are allocated to the first row of blanks, are delivered by the blank separating roll in a tangential direction which differs from the pieces of flat material allocated to the second row of blanks. Delivery in varying tangential directions is performed by the conveyors pertaining to the inventive device, in which a conveyor is allocated to each row of blanks. These conveyors, similar to the rows of blanks, are placed adjacently in the axial direction of the blank separating roll.

According to the invention, this offers the advantage that the pieces of flat material allocated to the two rows of blanks are spaced vertically due to the effect of the blank separating roll. If required, a horizontal spacing of the pieces of flat material allocated to the individual rows of blanks can be added to or overlaid with the vertical spacing. If the horizontal spacing is to occur simultaneously with the vertical spacing, the conveyors are arranged to be divergent not only in the vertical, but also in the horizontal direction. Alternatively, it is feasible that the conveyors initially run only in the vertical direction, and subsequently, in the direction of conveyance further towards the front, said devices additionally or exclusively run horizontally in different directions. The inventive vertical spacing of the pieces of flat material, which are allocated to the individual rows of blanks, especially enables the spacing of pieces of flat material of laterally interfering rows of blanks, which by no means would allow an exclusive lateral spacing, because, due to their specific contour geometry, the pieces of flat material of the adjacent rows of blanks would collide during the movement of the curve which then would occur in a single plane.

Vacuum devices required not only for controlling the vacuum for the cutting roll, but basically also for controlling the vacuum applied to the blank separating roll, are generally known. In this respect, an exemplified reference is made to DE 198 41 834 A1. Conveyors used for conveying pieces of flat material in various tangential directions of the blank separating roll may be suction conveyors in which the air is sucked through one or several perforated suction conveyors or through the gaps of several adjacent suction conveyors, or said devices may be roller conveying devices comprising several conveyor rollers placed adjacently in the direction of conveyance.

With more than two rows of blanks, it is feasible to allocate a different tangential direction to each row of blanks, in which the pieces of flat material allocated to the respective row of blanks are moved away from the blank separating roll. However, in the case of more than two rows of blanks, only two tangential directions are preferably provided for moving the pieces of flat material away from the blank separating roll, in which pieces of flat material allocated to the adjacent rows of blanks respectively are moved away in different tangential directions. Subsequently, two surfaces are mounted from the conveyors, which preferably, but essentially are located vertically above each other and intersect at a certain angle. If required, of course, it also is feasible to provide more than two, but fewer tangential directions than there are rows of blanks.

c) Embodiments

Various forms of embodiments of the present invention are exemplified by referring to the drawings. Of the drawings:

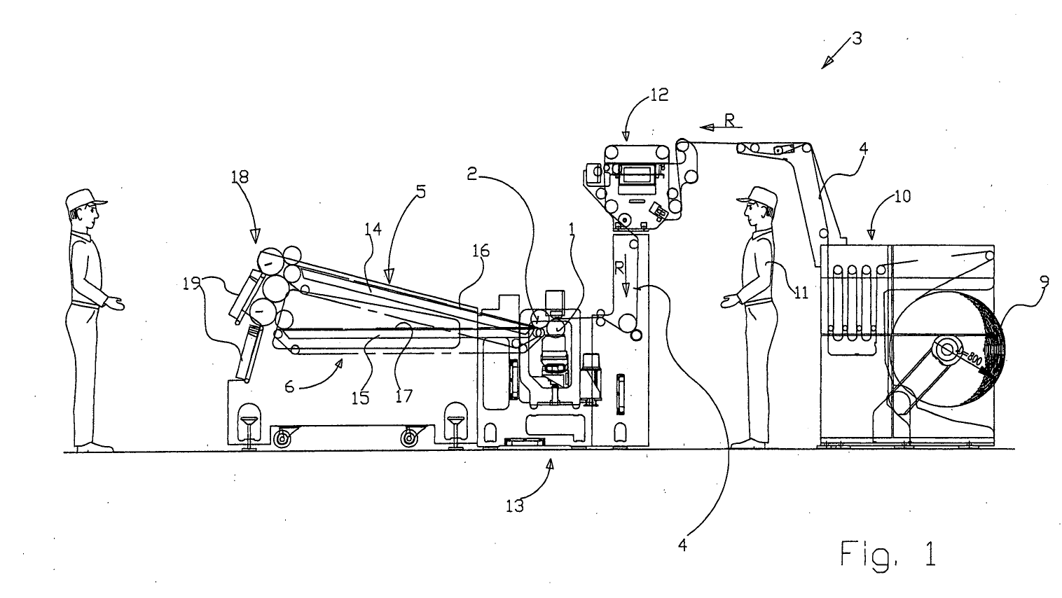

FIG. 1 shows a side elevation of a machine producing wet gummed labels cut out of a paper web by means of an inventive device for blank separation;

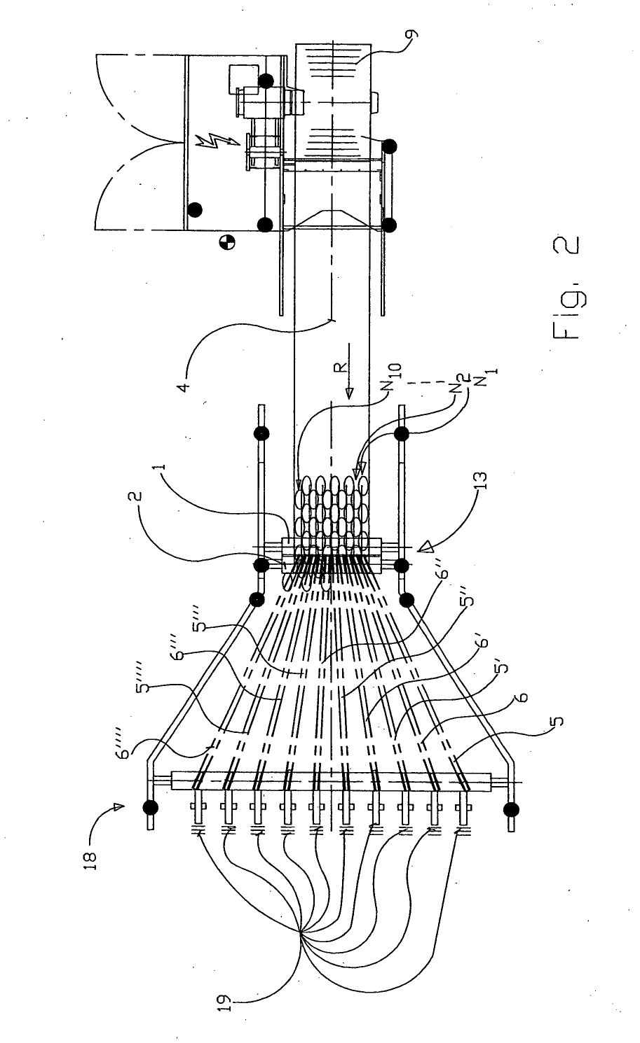

FIG. 2 shows a horizontal projection of the machine shown in FIG. 1;

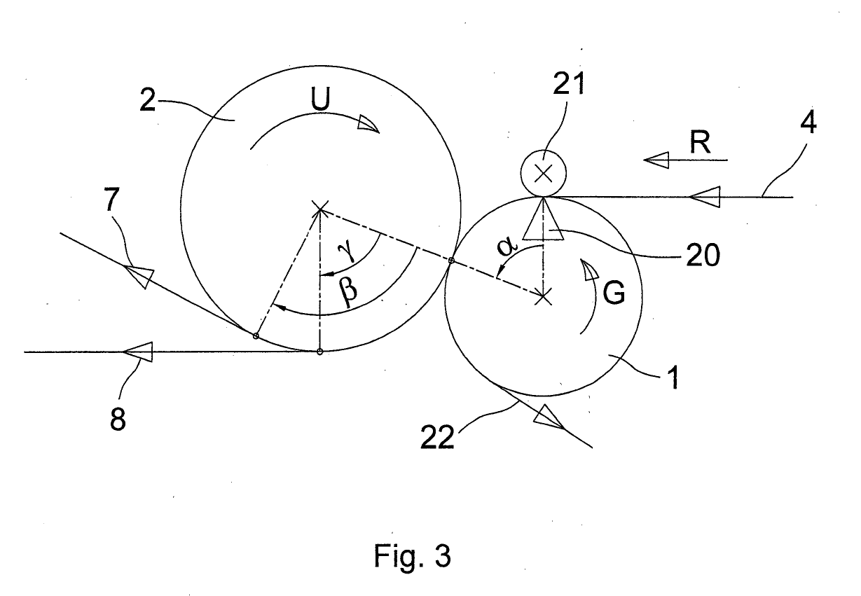

FIG. 3 shows a section of a schematic representation of an inventive device for blank separation; and

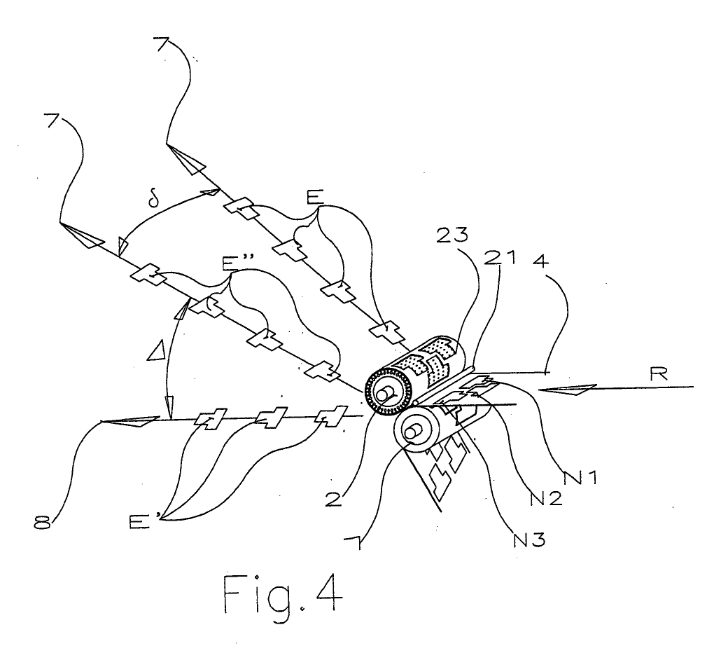

FIG. 4 shows a perspective view of an inventive device for blank separation comprising three rows of blanks.

The drawings explain the present invention by an example of producing wet gummed labels made of paper for application on beverage bottles, sandwich spread jars, and similar food containers. Of course, the invention may also be used in connection with other, flexible pieces of flat material, for example, in the production of flexible and/or easily bendable metal lids for food containers, such as yogurt cups. So long as the pieces of flat material to be produced are adequately flexible for application to the circumference of cutting or blank separating rolls, it is feasible to apply the present invention by any means for pieces of flat material to be cut out.

FIG. 1 shows a side elevation of a machine 3 for producing wet gummed labels from a paper web 4, which functions as a web. The paper web 4, which is printed with the desired image, is rolled off a supply roll 9 and runs through the machine 3 in the direction of conveyance according to the arrow R. After unwinding from the supply roll 9, the paper web 4 enters a buffer station 10 and subsequently is conveyed at the overhead height of an operator 11. Subsequently, in a lateral adjustment station 12, which is located approximately at the overhead height, the paper web 4 then is aligned laterally. If required, the paper web 4 may be printed only in the area of the lateral adjustment station 12.

After being adjusted, the paper web 4 is fed in the direction of conveyance R to a cutting and blank separating station 13. Said station comprises a cutting roll 1 by means of which the wet gummed labels are cut by way of rotation out of the paper web 4, and a blank separating roll 2 which follows in the direction of conveyance R, by means of which the wet gummed labels, which are allocated to the individual rows of blanks, are conveyed in two different tangential directions of the blank separating roll 2 to a total of ten conveyors in the form of suction conveyors, of which FIG. 1 only shows the suction conveyors 5 and 6 (refer to FIG. 2). In FIG. 1, especially the vacuum boxes 14, 15 and the suction conveyors 16, 17 of the suction conveyors 5, 6 are identifiable, said suction conveyors running continuously around the drive and/or deflection rollers. The cut wet gummed labels are retained on the suction conveyers 16, 17 in a generally known manner in that the ambient air is taken in through the perforation holes in the suction conveyor 16, 17 and/or through the gaps between several parallel suction conveyors into the suction boxes 14, 15, when the suction conveyors 5, 6 respectively consist of several suction conveyors. At the left-hand side of the machine 3, in FIG. 1, the finished wet gummed labels are delivered by the suction conveyors 16, 17 to a delivery station 18 by means of which said labels are deposited into cartridges 19. The cartridges 19 preferably are of a type in which the bottling devices can be used directly in the labeling machines of said devices, i.e., without transferring the wet gummed labels to other containers.

In a horizontal projection according to FIG. 2, the printed image applied to the paper web 4 can be identified, as is indicated with ellipses. In the shown embodiment, a total of ten rows of blanks N₁, N₂ through N₁₀ are provided adjacently in the direction of conveyance R. When the cutting roll 1 rotates, a total of ten wet gummed labels are thus cut. The blank separating roll 2 takes these ten wet gummed labels from the cutting roll 1 and transfers said labels to a total of ten different conveyors 5, 6, 5′, 6′, 5″, 6″, 5′″, 6′″, 5″″ and 6″″, which actively convey the wet gummed labels from the blank separating roll 2. Further, in terms of the blank separating roll 2, the wet gummed labels cut out of the first row of blanks N₁ are placed onto the conveyor 5 in a first tangential direction 7, which can be identified in FIG. 3, and, in terms of the blank separating roll 2, the wet gummed labels cut out of the row of blanks N₂ are placed onto a second conveyor 6 in the tangential direction 8, which is identified in FIG. 3, in that the latter device is placed adjacent to the conveyor 5 as shown in FIG. 2. The wet gummed labels are delivered in a similar manner to the rows of blanks N₃, N₄ and the conveyors 5′, 6′, the rows of blanks N₅, N₆ and the conveyors 5″, 6″, the rows of blanks N₇, N₈ and the conveyors 5′″, 6′″, as well as the rows of blanks N₉, N₁₀ and the conveyors 5″″, 6″″. The conveyors 5, 5′, 5″, 5′″, and 5″″ thus run in the same first tangential direction 7, while the conveyors 6, 6′, 6″, 6′″, 6″″ run in the second tangential direction 8 which, according to FIG. 3, differs from the first tangential direction 7. The wet gummed labels allocated to the rows of blanks N₁, N₃, N₅, N₇ and N₉ thus are spaced vertically upward and downward by the wet gummed labels, which are allocated to the rows of blanks N₂, N₄, N₆, N₈ and N₁₀, i.e., in the direction of viewing of FIG. 2 and/or FIG. 1 in the plane of projection.

It is of particular advantage when the individual wet gummed labels, which are allocated to the respective rows of blanks N₁ through N₁₀, are spaced not only vertically, but also horizontally, i.e., upward and downward in the plane of projection of FIG. 2 and/or in the viewing direction in FIG. 1. As a result, this not only creates the necessary space in the vertical, but also in the horizontal direction, in order to be able to place the mechanical units for the automated delivery by means of the delivery station 18. Accordingly, the conveyors 5, 6, 5′, 6′, 5″, 6″, 5′″, 6′″, 5″″ and 6″″, run from the blank separating roll 2 in different directions in a fan-like manner, as shown in FIG. 2. Alternatively, it is feasible to initially place the aforesaid conveyors a certain distance behind the blank separating roll 2 in and/or parallel to the direction of conveyance R, and to fan out said devices horizontally only at a corresponding distance from the blank separating roll. As is indicated in the combined view of FIG. 1 and 2, the shown embodiment comprises two conveyance levels above each other, in which in the upper conveyance level the conveyors 5, 5′, 5″, 5″″, and 5″″ extend fan-like, while in the lower conveyance level the directions of conveyance 6, 6′, 6″, 6′″, and 6″″ run fan-like.

FIG. 3 shows a schematic representation of the inventive blank separation in a sectional view. According to arrow G, the printed paper web 4 is fed counterclockwise to the rotating cutting roll 1. The cutting edge 20, which corresponds to the desired label geometry, is merely indicated schematically. The cut is made against a counterstrip and/or backing roll 21 which, as required, may be stationary and/or rotating. The vacuum control of the cutting roll 1 ensures that the wet gummed labels of all rows of blanks N₁ through N₁₀ are retained at the cutting roll 1 via an angle at circumference α. After passing through the angle at circumference α, the vacuum control of the cutting roll 1 delivers the wet gummed labels of all rows of blanks N₁ through N₁₀ to the blank separating roll 2, which rotates clockwise according to the arrow U. The vacuum control device of said roll applies vacuum in such a manner to those vacuum orifices which retain the wet gummed labels allocated to the rows of blanks N₁, N₃, N₅, N₇ and N₉, that said labels are retained at the circumference of the blank separating roll 2 via the angle at circumference β. After passing through the angle at circumference β, said labels are delivered in the first tangential direction 7 to the conveyors 5, 5′, 5″, 5′″, and 5″″. The wet gummed labels, which are allocated to the rows of blanks N₂, N₄, N₆, N₈ and N₁₀, are retained by the vacuum device of the blank separating roll 2 merely via the angle at rotation Ψ at the circumference of the blank separating roll 2, in which the angle Ψ is smaller than the angle β. The delivery of the wet gummed labels, which are allocated to the blanks N₂, N₄, N₆, N₈ and N₁₀ is thus effected in the second tangential direction 8, i.e., at a level which runs below the level in which the wet gummed labels are located to the rows of blanks N₁, N₃, N₅, N₇ and N₉ are delivered. The waste 22 produced by the paper web is retained by the suction device of the cutting roll 1 beyond the angle at circumference α at the circumference of the roll, and preferably is sucked off in the lower section of the cutting roll 1.

FIG. 4 shows a perspective view of another inventive device for blank separation, in which a total of three rows of blanks N₁, N₂, and N₃ are provided. The wet gummed labels E, E′, and E″, which are to be produced, for example, are T-shaped. As is shown in the printed image of the paper web 4, the rows of blanks N₁, N₂, and N₃ interfere with each other laterally as a result of minimizing the waste produced by the paper web, because the contour lines of the labels of the central rows of blanks N2 are twisted by 180° opposite the contour lines of the labels of the rows of blanks N₁ and N₃. At the blank separating roll 2, the vacuum orifices can be identified in the peripheral area of said roll. Furthermore, the vacuum ducts are indicated at the front face of the blank separating roll 2. The cutting roll 1 comprises corresponding vacuum orifices and vacuum ducts (not shown). Similar to FIG. 3, the cut also is made against a stationary or rotating counterstrip or backing roll 21. The blank separating roll 2 is covered with a stencil foil 23 into which openings are made corresponding to the geometry of the wet gummed labels E, E′, and E″ to be produced. With a given label geometry, this causes only those vacuum orifices to develop a suction effect, which is required for the specific label geometry. All other vacuum orifices in the peripheral area of the blank separating roll 2 are covered in a simple manner by means of stencil foil 23, which not only prevents interfering inleakage, but also facilitates vacuum control in the blank separating roll 2.

The vacuum device in the blank separating roll 2 can be controlled so that the wet gummed labels E and/or E″, which are allocated to the rows of blanks N₁ and/or N₃, are released later, by the blank separating roll 2, than the wet gummed labels E′ allocated to the central rows of blanks N₂. As a result, the wet gummed labels E and/or E″ are delivered in the first tangential direction 7 which, by the angle Δ, deviates from the second tangential direction 8 in which the wet gummed labels E′ are delivered, said labels being allocated to the central row of blanks N₂. In the embodiment shown in FIG. 4, the wet gummed labels E, E′, and E″ preferably also are spaced horizontally, in that the wet gummed labels E and E″ run horizontally in different directions at an angle of expansion δ.

From the aforesaid description it follows that this invention ensures that wet gummed labels, which by way of rotation are cut out of adjacent rows of blanks placed very close together, can be spaced by a simple method, thus enabling mechanical handling of wet gummed labels during automatic delivery, so that various label orders can be processed simultaneously. For example, with a total of ten rows of blanks, two rows of blanks may be used for a first order comprising a first label geometry, and the remaining eight rows of blanks for a second order comprising the second label geometry. As a result of placing the wet gummed labels into cartridges which can be used directly in the customers' labeling machines, corresponding customers can be supplied directly after completion of the respective order. This approach enables an improved utilization of machines when handling small orders, in which the pieces of flat material in question are produced.

### List of Reference Signs

1 Cutting roll

2 Blank separating roll

3 Machine

4 Web

5 First conveyor

6 Second conveyor

7 First tangential direction

8 Second tangential direction

9 Supply roll

10 Buffer station

11 Operator

12 Lateral control station

13 Cutting and blank separating station

14 Suction box

15 Suction box

16 Suction conveyor

17 Suction conveyor

18 Delivery station

19 Cartridges

20 Cutting edge

21 Counter strip/backing roll

22 Waste produced by the paper web

23 Stencil foil

1. A device for blank separation in a machine producing pieces of flat material cut out of a web, in which the web in one direction of conveyance is guided through the machine, and the web comprises at least two rows of blanks at right angles to the direction of conveyance, and in which the device comprises a cutting roll for cutting pieces of flat material out of the web, characterized in that a blank separating roll is provided which accepts the pieces of flat material of each row of blanks for retaining the pieces of flat material at the peripheral area of said roll, in which at least two conveyors are provided and in which the vacuum device is so controllable that the pieces of flat material allocated to the first row of blanks can be delivered in the first tangential direction of the blank separating roll to the first conveyor, and the pieces of flat material allocated to the second row of blanks can be delivered in the second tangential direction of the blank separating roll to the second conveyor.

2. The device as defined in claim 1, characterized in that the conveyors are placed at right angles to the direction of conveyance and horizontally run in different directions.

3. The device as defined in claim 1 or 2, characterized in that the first conveyor is a suction conveyor.

4. The device as defined in claim 1 characterized in that the first conveyor is a roller conveyor.

5. A machine for producing pieces of flat material cut out of a web, comprising a device for blank separation, wherein the device for blank separation is configured to produce pieces of flat material cut out of a web, in which the web in one direction of conveyance is guided through the machine, and the web comprises at least two rows of blanks at right angles to the direction of conveyance, and in which the device comprises a cutting roll for cutting pieces of flat material out of the web, characterized in that a blank separating roll is provided which accepts the pieces of flat material of each row of blanks for retaining the pieces of flat material at the peripheral area of said roll, in which at least two conveyors are provided and in which the vacuum device is so controllable that the pieces of flat material allocated to the first row of blanks can be delivered in the first tangential direction the blank separating roll to the first conveyor, and the pieces of flat material allocated to the second row of blanks can be delivered in the second tangential direction of the blank separating roll to the second conveyor.

6. A process for blank separation in a machine producing pieces of flat material cut out of a web, in which, prior to the blank separation, the web is guided in one direction of conveyance through the machine, in which the web is provided with at least two rows of blanks placed at right angles to the direction of conveyance and the pieces of flat material are cut out of the web, characterized in that after the cutting out operation the pieces of flat material of each row of blanks are fed to a blank separating roll which comprises a vacuum device for retaining the pieces of flat material at the peripheral area of said roll, and by means of a vacuum control the pieces of flat material, which are allocated to the first rows of blanks, are delivered in a first tangential direction of the blank separating roll to the first conveyor, and the pieces of flat material allocated to the second row of blanks are delivered in the second tangential direction of the blank separating roll to the second conveyor.

7. The process according to claim 6, characterized in that the pieces of flat material allocated to the various rows of blanks are spaced horizontally following the vertical spacing, which is contingent upon delivery in the various tangential directions.

8. The process according to claim 6, characterized in that the pieces of flat material allocated to the various rows of blanks are spaced horizontally during the vertical spacing, which is contingent upon delivery in the various tangential directions.

9. The device as defined in claim 1, characterized in that the second conveyor is a suction conveyor.

10. The device as defined in claim 1, characterized in that the second conveyor is a roller conveyor.

11. The device as defined in claim 2, characterized in that the first conveyor is a suction conveyor.

12. The device as defined in claim 2, characterized in that the second conveyor is a suction conveyor.

13. The device as defined in claim 2, characterized in that the first conveyor is a roller conveyor.

14. The device as defined in claim 2, characterized in that the second conveyor is a roller conveyor.

15. The device as defined in claim 5, characterized in that the conveyors are placed at right angles to the direction of conveyance and horizontally run in different directions.

16. The device as defined in claim 5, characterized in that the first conveyor is a roller conveyor.

17. The device as defined in claim 5, characterized in that the second conveyor is a roller conveyor.

18. The device as defined in claim 5, characterized in that the first conveyor is a suction conveyor.

19. The device as defined in claim 5, characterized in that the second conveyor is a suction conveyor.

20. The device as defined in claim 15, characterized in that the first conveyer is one selected from the group consisting of a roller conveyor and a suction conveyor, and the second conveyor is one selected from the group consisting of the roller conveyor and the suction conveyor.
